(19) United States
(12) Patent Application Publication
(10) Pub. No.: US 2007/0252798 A1
(43) Pub. Date: Nov. 1, 2007

(54) Liquid crystal display with image data inversion and driving method thereof

(75) Inventor: Shao-Qiang Wu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/796,775

(22) Filed: Apr. 30, 2007

(30) Foreign Application Priority Data
Apr. 28, 2006 (TW) 95115318

(51) Int. Cl. G09G 3/36

(52) U.S. Cl. 345/87

(57) ABSTRACT

A driving circuit (25) for a liquid crystal display connecting to a host is provided. The driving circuit includes an image memory (251), a comparator (253), a counter (255) and an image converting means (259). The image memory stores a former frame's image data. The comparator compares a latter frame's image data provided by the host with the former frame's image data. The counter has a predetermined first threshold value and is configured to record an ongoing number of consecutive frames during which a latter frame's image data are the same as a former frame's image data. The converting means inverts a latter frame's image data into inverted frame image data when the ongoing number reaches the first threshold value.

### BACKGROUND OF THE INVENTION

1. Field of the Invention

The present invention relates to a driving circuit of a liquid crystal display, and method of driving a liquid crystal display to display images.

2. General Background

A typical liquid crystal display (LCD) generally includes a display panel controlled by a driving circuit, and a backlight module for illuminating the display panel. The profiles of the display panel and the backlight module are much thinner than that of a typical cathode ray tube (CRT) display. Therefore by choosing an LCD, a large amount of space can be saved in the home or at work.

Referring to FIG. 2, this is a block diagram showing a driving module 10 of a conventional LCD. The driving module 10 includes an image input port 11, an image output port 13, an image generator 15, and a driving circuit 17. Image data from a host are received by the image input port 11 of the driving module 10, and then transmitted to the driving circuit 17. After the image data are processed and analyzed by the driving circuit 17, the image data can be sent to the image output port 13, or a trigger signal can be provided to enable the image generator 15 to generate a predetermined image for the image output port 13.

The driving circuit 17 includes an image memory 171, a comparator 172, and a counter 173. The image memory 171 can store image data of a former time frame (or “former frame”), which image data produce an image shown by a display panel of the LCD. The comparator 172 compares image data of an immediately succeeding latter time frame (or “latter frame”) provided by the host with the former frame's image data stored in the image memory 171. The counter 173 is preprogrammed with a predetermined threshold value, and records an ongoing counting value. When the counting value reaches the threshold value, the counter 173 provides a trigger signal to enable the image generator 15.

When a latter frame's image data are received by the image input port 11 and provided to the comparator 172, the comparator 172 compares the latter frame's image data with a former frame's image data stored in the image memory 171. If a difference exists between the latter frame's image data and the former frame's image data, the latter frame's image data are sent to the image output port 13 directly. If the latter frame's image data are the same as the former frame's image data, a counting signal is provided to the counter 173. Thereby, the ongoing counting value stored by the counter 173 is incremented by a value of one.

When the ongoing counting value increases and eventually reaches the threshold value, the counter 173 sends a trigger signal to enable the image generator 15. The image generator 15 then generates a predetermined image for the image output port 13 of the driving module 10. The predetermined image is inserted and displayed between the two current static (i.e., identical) frames. Thus, molecules of liquid crystal in the display panel are protected from being ionized. Thereby, one of the primary causes of image sticking problems in the display panel is reduced or even eliminated, so that the display panel can display quality images.

Generally, the image generator is a complicated and costly graphics chip. Hence, there is a need for an inexpensive configuration associated with a driving circuit of an LCD.

### SUMMARY

Embodiments of the invention provide a driving circuit for a liquid crystal display and driving method for a liquid crystal display.

One embodiment of the invention provides a driving circuit for a liquid crystal display. The driving circuit includes an image memory, a comparator, a counter and an image converting means. The image memory stores a former frame's image data. The comparator is configured for comparing a latter frame's image data provided by a host with a former frame's image data provided by the host. The counter has a set predetermined first threshold value, and is configured to record an ongoing number of consecutive frames during which a latter frame's image data are the same as the former frame's image data. The converting means inverts the latter frame's image data into inverted frame image data when the ongoing number reaches the first threshold value.

Furthermore, the latter frame's image data are directly transferred to the liquid crystal display, and the second value is reset to zero when the latter frame's image data are different from the former frame's image data, or when the second value is smaller than the predetermined first threshold value.

The counter resets the second value to zero after the inverted frame image data are produced. The counter further has a predetermined third value of frames that the inverted frame image data is to be maintained when the former frame's image data are continuously the same as the latter frame's image data after the second value is reset to zero. The latter frame's image data is transferred to the liquid crystal display when the second value is equal to the predetermined third value after the inverted frame image data are produced, and the counter then resets the second value to zero.

Furthermore, the predetermined third value is smaller than the predetermined first threshold value. The converting means is an image inverter. A further embodiment of the invention provides a driving method for a liquid crystal display. The driving method of the includes the steps of: predetermining a first threshold value that provides a benchmark for an ongoing number of consecutive frames during which a latter frame's image data are the same as a former frame's image data; receiving frame image data from a host; comparing a latter frame's image data with a former frame's image data, and recording an ongoing number of consecutive frames during which a latter frame's image data are the same as a former frame's image data; and converting a latter frame's image data into inverted frame image data when the ongoing number reaches the first threshold value.

Moreover, the driving method further includes the steps of: predetermined a third value; and providing the inverted frame image data to the liquid crystal display for the third value of frames when the former frame's image data is continuously the same as the latter frame's image data after the second value is reset to zero.

Other novel features and advantages will become more apparent from the following detailed description when taken in conjunction with the accompanying drawings.

### BRIEF DESCRIPTION OF THE DRAWINGS

FIG. 1 is a block diagram of a driving module for a liquid crystal display, in accordance with an exemplary embodiment of the present invention.

FIG. 2 is a block diagram of a conventional driving module for a liquid crystal display.

### DETAILED DESCRIPTION

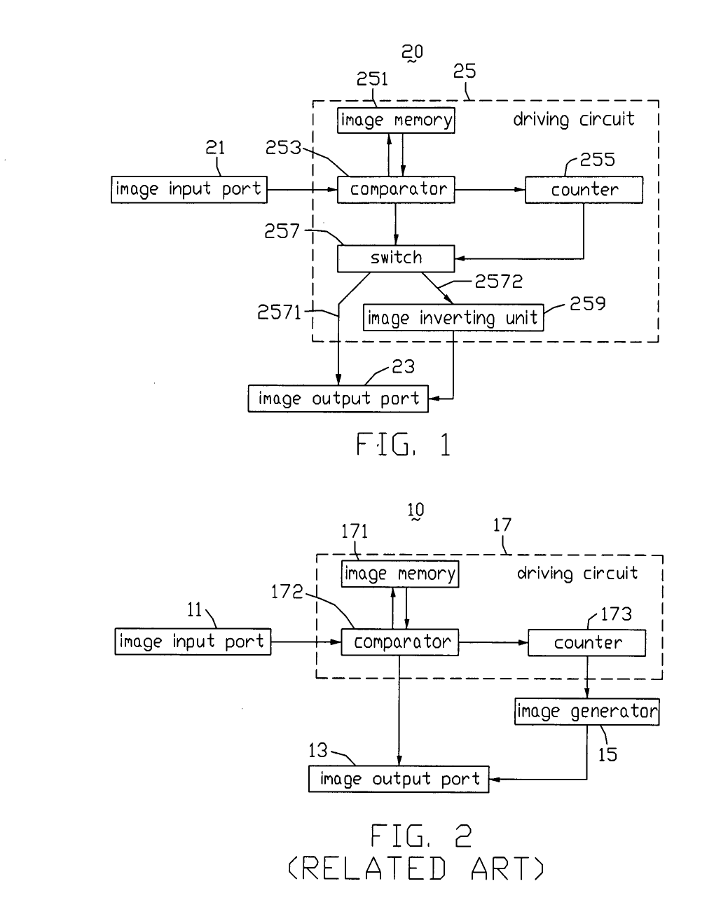

FIG. 1 is a block diagram of a driving module 20 for a liquid crystal display (LCD), in accordance with an exemplary embodiment of the present invention.

The driving module 20 includes an image input port 21, an image output port 23, and a driving circuit 25. Image data from a host (not shown) are received by the image input port 21 of the driving module 20, and then transmitted to the driving circuit 25. After the image data are analyzed by the driving circuit 25, original image data or processed image data can be provided to the image output port 23 of the driving module 20.

The driving circuit 25 includes an image memory 251, a comparator 253, a counter 255, a switch 257, and an image inverting unit 259 or an image inverter. The image memory 251 can be a DRAM (dynamic random access memory), flash RAM (random access memory), or another suitable kind of memory. The image memory 251 is used to store a former frame's image data, which image data produce an image shown by a display panel of the LCD. The comparator 253 compares an immediately succeeding latter frame's image data newly provided by the host with the former frame's image data stored in the image memory 251. The counter 255 stores a variable counting value P, and a predetermined first threshold value Q. A value recorded by the counter 255 is incremented by the comparator 253 when the former frame's image data are the same as the latter frame's image data. The switch 257 has an input (not labeled), a first output 2571, and a second output 2572. The input of the switch 257 is connected to the comparator 253. The first output 2571 is connected to the image output port 23, and the second output 2572 is connected to the image inverting unit 259. The switch 257 can be triggered or enabled by the counter 255, and can transfer data to the first output 2571 or the second output 2572. The image inverting unit 259 can invert the image frame data provided from the host into inverted frame image data for the image output port 23, which inverted frame image data produce an image shown by the display panel later.

In an exemplary embodiment, when an (N+1)th frame's image data are received by the image input port 21 and provided to the comparator 253, the comparator 253 compares this latter, or (N+1)th, frame's image data with a former, or Nth, frame's image data stored in the image memory 251, in order to determine whether Nth and (N+1)th frames' image data are identical or not.

In a normal state, the switch 257 is connected to the first output 2571. In this state, each frame's image data can be directed to the image output port 23 of the driving module 20 through the first output 2571 of the switch 257. The (N+1)th frame's image data are directly transferred to the image output port 23 for the display panel to show a corresponding image, and the counting value P of the counter 255 is reset to zero when the (N+1)th frame's image data are different from the Nth frame's image data stored in the image memory 251. The (N+1)th frame's image data are then saved in the image memory 251.

When the (N+1)th frame's image data are identical to the Nth frame's image data stored in the image memory, a counting signal is provided to enable the counter 255 Accordingly, the counting value P stored by the counter 255 is incremented by a value of one. Simultaneously, the (N+1)th frame's image data are directly transferred to the image output port 23 for the display panel to show a corresponding image, and the identical Nth frame's image data are kept stored in the image memory 251. That is, the (N+1)th frame's image data are not written over the identical Nth frame's image data stored in the image memory 251.

Alternatively, the (N+1)th frame's image data can be saved into the image memory 251. If this means is adopted, the complexity of the driving circuit 25 may be simplified.

Furthermore, when the following Q frames of image data are all (continuously) identical to the Nth frame's image data, and the counting value P in the counter 255 reaches the predetermined first threshold value Q, a trigger signal is provided by the counter 255 to enable the switch 257. Accordingly, the switch 257 is connected to the second output 2572. The (N+Q)th frame's image data are directed to the image inverting unit 259 through the second input port 2572 of the switch 257. The image inverting unit 259 immediately inverts the (N+Q)th frame's image data into inverted frame image data, and transfers the inverted frame image data to the image output port 23 of the driving module 20 for the display panel to show a corresponding image. The inverted frame image data are preferred to the data that can show an inverted color, or optically compensated color, of the (N+Q)th frame image data.

In another embodiment, the counting value P is reset to zero after the inverted frame image data are produced. The counter 255 further has a predetermined second threshold value R. R is a number of frames throughout which the inverted frame image data are to be maintained when the former frame's image data are continuously identical to the latter frame's image data after the counting value P is reset to zero. The first threshold value Q is preferably larger than the second threshold value R. An inverted frame image corresponding to the inverted frame image data is inserted and displayed for P frames between a plurality of continuously identical, or static, frame images. Thus, molecules of liquid crystal in the display panel are protected from being ionized. Thereby, one of the primary causes of image sticking problems in the display panel is reduced or even eliminated, so that the display panel can display quality images.

In the above-described exemplary embodiment, the switch 257 and the image inverting unit 259 in effect replace the image generator 15 of the conventional driving module 10. In this regard at least, the driving circuit 25 has a simplified configuration. Therefore the cost of the driving module 20 can be greatly reduced.

While the above description has been by way of examples and in terms of preferred embodiments, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

We claim:

1. A driving circuit for a liquid crystal display, the driving circuit comprising:
a comparator configured for comparing a latter frame's image data provided by a host with a former frame's image data provided by the host;
converting means for inverting the latter frame's image data; and
a counter having a set predetermined first threshold value, and configured to record an ongoing number of consecutive frames during which a latter frame's image data are the same as a former frame's image data;
wherein the converting means inverts a latter frame's image data into inverted frame image data when the ongoing number reaches the first threshold value.

2. The driving circuit as claimed in claim 1, wherein the latter frame's image data are directly transferred to a display panel of the liquid crystal display, and the an ongoing number is reset to zero when the latter frame's image data are different from the former frame's image data.

3. The driving circuit as claimed in claim 1, wherein the latter frame's image data are directly transferred to a display panel of the liquid crystal display when the ongoing number is less than the first threshold value.

4. The driving circuit as claimed in claim 1, wherein the counter resets the ongoing number to zero after the inverted frame image data are produced.

5. The driving circuit as claimed in claim 4, wherein the counter further has a set predetermined second threshold value of frames during which the inverted frame image data are to be maintained when the former frame's image data are continuously the same as the latter frame's image data after the ongoing number is reset to zero.

6. The driving circuit as claimed in claim 5, further comprising:
a switch connecting to the comparator, the converting means, and an image output port,
wherein the switch is shifted to the image output port, and the latter frame's image data are transferred to the image output port for the liquid crystal display when the ongoing number reaches the second threshold value after the inverted frame image data are produced, and the counter then resets the ongoing number to zero.

7. The driving circuit as claimed in claim 6, wherein the second threshold value is less than the first threshold value.

8. The driving circuit as claimed in claim 1, further comprising an image memory connected to the comparator and configured for storing a former frame's image data.

9. The driving circuit as claimed in claim 1, wherein the converting means comprises an image inverter.

10. A driving method for a liquid crystal display, comprising:
predetermining a first threshold value that provides a benchmark for an ongoing number of consecutive frames during which a latter frame's image data are the same as a former frame's image data;
receiving frame image data from a host;
comparing a latter frame's image data with a former frame's image data, and recording an ongoing number of consecutive frames during which a latter frame's image data are the same as a former frame's image data; and
converting a latter frame's image data into inverted frame image data when the ongoing number reaches the first threshold value.

11. The driving method as claimed in claim 10, further comprising:
transferring the latter frame's image data directly to the liquid crystal display when the latter frame's image data are different from the former frame's image data, and
resetting the ongoing number to zero.

12. The driving method as claimed in claim 10, further comprising transferring the latter frame's image data directly to the liquid crystal display when the ongoing number is smaller than the predetermined first threshold value.

13. The driving method as claimed in claim 10, further comprising resetting the second value to zero after the inverted frame image data are produced.

14. The driving method as claimed in claim 13, further comprising:
predetermined a second threshold value of frames; and
providing the inverted frame image data to the liquid crystal display for the second threshold value of frames when the former frame's image data are continuously the same as the latter frame's image data after the ongoing number

15. The driving method as claimed in claim 14, further comprising providing the latter frame's image data to the liquid crystal display after the inverted frame image data are provided for the second threshold value of frames.

16. The driving method as claimed in claim 14, wherein the second threshold value is less than the first threshold value.

17. A driving circuit for a liquid crystal display, the driving circuit comprising:
a comparator configured for comparing a latter frame's image data provided by a host with a former frame's image data provided by the host;
a counter having a set predetermined first threshold value, and configured to record an ongoing number of consecutive frames during which a latter frame's image data are the same as a former frame's image data; and
a switch connected to the counter and determining whether a latter frame's image data either directly go to an image output port or indirectly through a converting means which inverts a latter frame's image data into inverted frame image data when the ongoing number corresponds to the first threshold value.
